(19) United States
(12) Patent Application Publication
(10) Pub. No.: US 2019/0190771 A1
(43) Pub. Date: Jun. 20, 2019

(54) CLOUD SERVICE MANAGEMENT METHOD

(71) Applicant: GEMINI OPEN CLOUD COMPUTING INC., HSINCHU CITY (TW)

(72) Inventor: Cheng-Yi Fang, HSINCHU CITY (TW)

(21) Appl. No.: 15/858,933

(22) Filed: Dec. 29, 2017

(30) Foreign Application Priority Data
Dec. 20, 2017 (TW) 106144806

(51) Int. Cl. H04L 12/24

(52) U.S. Cl. CPC H04L 41/0273; H04L 41/5048; H04L 41/0266; H04L 41/22; H04L 41/0813

(57) ABSTRACT

A cloud service management method may manage cloud computing services provided over an Internet connection. The method for cloud service management includes: providing a controller node having a cloud service template parser and a management application; providing a service builder for a user to set up a cloud service template and transmitting the cloud service template to the cloud service template parser; the cloud service template parser parsing the cloud service template, establishing multiple virtual environments in a cloud platform, installing an agent application in each virtual environment, setting a first parameter group corresponding to the management application in the control node, and setting a second parameter group corresponding to the agent application in each virtual environment, so as to provide a cloud service; and managing the cloud service through the management application communicatively connected to the agent application.

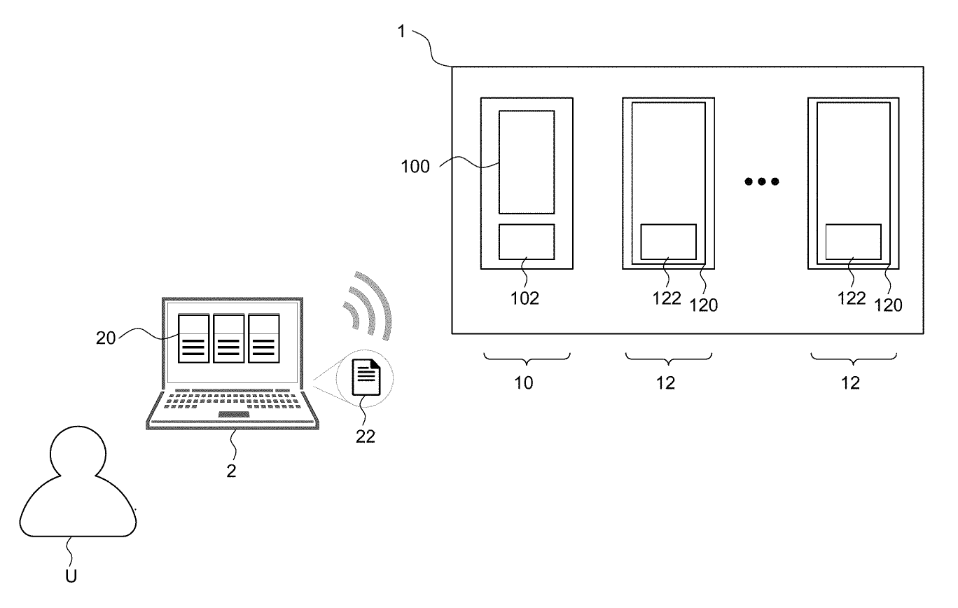

### BACKGROUND OF THE INVENTION

### 1. Field of the Invention

The present invention relates to a cloud service management method, particularly to a management method for computer cloud computing services provided over an Internet connection.

### 2. Description of the Prior Art

A complete cloud service involves a plurality of network elements respectively operating in different virtual machines and interconnecting with each other inside an identical firewall, such as the front-end service elements, the back-end service elements, and data store service elements. Cloud computing can realize Internet-based information technology services, i.e. cloud services, such as Software as a Service (SaaS), Platform as a Service. (PaaS), and Infrastructure as a Service (IaaS).

At present, PaaS and IaaS allow users to only administrate or monitor the utilization status of the virtual resources in the cloud platforms, i.e. undertake provisioning and monitoring of the virtual resources, which correlates with the hardware resources of the servers. However, the utilization status of the virtual resource neither accurately presents the operation status of the cloud service nor allows the user to administrate the contents of the cloud service flexibly; that is, the user is unlikely to reconfigure or update the cloud service. For example, the cloud service provider provides an online shopping mall platform for users, whereby the sellers (i.e. users) can establish their own shops to sell goods. While a user intends to change the desktop or vary the number of the goods shown in each page, he does not intend to reconfigure the virtual resources but has to reconfigure or update the contents of the cloud service.

In the conventional technology, while intending to undertake succeeding management and monitoring of the contents and functions of the cloud service, the user has to access the Internet to enter the virtual environment and operate in the virtual environment, or establish and set up corresponding management tools by himself.

Therefore, an easy-to-use cloud service management method is a target the related manufacturers are eager to achieve.

### SUMMARY OF THE INVENTION

The present invention provides a cloud service management method, wherein while the cloud service is established, an agent application is automatically installed in each virtual environment simultaneously, and the corresponding parameter group is also set up, whereby the user can manage the cloud service in real time.

In one embodiment, the present invention provides a cloud service management method for managing an Internet-based clouding computing service. The cloud service management method comprises steps: providing a controller node having a cloud service template parser and a management application; providing a service builder for a user to set up a cloud service template and transmitting the cloud service template to the cloud service template parser; the cloud service template parser parsing the cloud service template, establishing multiple virtual environments in a cloud platform, installing an agent application in each virtual environment, setting a first parameter group corresponding to the management application in the control node, and setting a second parameter group corresponding to the agent application in each virtual environment, so as to provide a cloud service; and managing the cloud service through the management application communicatively connected to the agent application.

Below, embodiments are described in detail in cooperation with the attached drawings to make easily understood the objectives, technical contents, characteristics and accomplishments of the present invention.

### BRIEF DESCRIPTION OF THE DRAWINGS

The sole FIGURE is a diagram schematically showing a cloud platform according to one embodiment of the present invention.

### DESCRIPTION OF THE PREFERRED EMBODIMENTS

The present invention will be described in detail with embodiments and attached drawings below. However, these embodiments are only to exemplify the present invention but not to limit the scope of the present invention. In addition to the embodiments described in the specification, the present invention also applies to other embodiments. Further, any modification, variation, or substitution, which can be easily made by the persons skilled in that art according to the embodiment of the present invention, is to be also included within the scope of the present invention, which is based on the claims stated below. Although many special details are provided herein to make the readers more fully understand the present invention, the present invention can still be practiced under a condition that these special details are partially or completely omitted. Besides, the elements or steps, which are well known by the persons skilled in the art, are not described herein lest the present invention be limited unnecessarily. Similar or identical elements are denoted with similar or identical symbols in the drawings. It should be noted: the drawings are only to depict the present invention schematically but not to show the real dimensions or quantities of the present invention. Besides, matterless details are not necessarily depicted in the drawings to achieve conciseness of the drawings.

Refer to the sole FIGURE. A cloud platform 1 can execute a cloud service management method according to one embodiment of the present invention to manage an Internet-based cloud computing service. In general, the cloud platform 1 contains a plurality of nodes respectively having different functions. The nodes may be but is not limited to be a controller node 10, a compute node 12 and a storage node (not shown in the drawing). In one embodiment, different virtual environments 120 are established in different compute nodes 12 (the physical host servers). The virtual environment 120 includes at least one of a virtual machine and a container.

Below is described the cloud service management method of this embodiment. Firstly, provide a controller node 10 with a cloud service template parser 100 and a management application (so-called management server) 102 built therein. In one embodiment, the cloud service template parser 100 is an application program generated by a web application framework. The web application framework may be but is not limited to be a Django web application framework. In one embodiment, the cloud service template parser has a management interface, and the user may operate the management interface through an Internet link. The management interface may be a graphic user interface (GUI) or an application programming interface (API). Thereby, a cloud service template 22 can be uploaded to the cloud platform 1 through the management interface of the cloud service template parser 100.

In one embodiment, the management application 102 includes a configuration tool management program or a monitoring management program. In one embodiment, the configuration tool management program is the Salt Master application program or the Puppet Master application program; the monitoring management program is the Zabbix Server application program or the Nagios Server application program. However, the present invention is not limited by the abovementioned embodiment. It should be explained herein: the aim of installing the management application 102 is to exempt the user U from accessing the Internet for entering the complicated virtual environment 120 and viewing the original data and the operation status. In the present invention, the user U can manage the cloud service via merely linking to the management application 102. However, if the cloud service provider only installs the management application 102, the user U is still unable to use the management application 102 to manage or monitor the contents of the cloud service. The detail thereof will be described below.

Refer to the sole FIGURE again. In one embodiment, the cloud service management method of the present invention comprises providing a service builder 20 enabling the user U to establish a cloud service template 22 and transmitting the cloud service template 22 to the cloud service template parser 100. The service builder 20 is installed in a user end 2. The user end 2 may be but is not limited to be a working computer communicatively connected with the controller node 1 or a web interface installed in a web server, and the user U can access the Internet to operate the service builder 20. In one embodiment, the prototype of the service builder 20 adopts a command-line interface or a graphic user interface to facilitate the user U to establish a cloud service template 22. For example, the user U can browse the cloud service template 22 through the graphic user interface, or establish and amend the contents of the cloud service template 22 by a drag-and-drop method. It is noted that the cloud service template 22 correlates with the management application 102.

In one embodiment, the service builder 20 may be but is not limited to be practiced by a cross-platform language, such as Java or Python, which enables the user U to use the service builder 20 in different operating systems. Therefore, it is unnecessary for the user U to be familiarized with the operating environments and technical details of different operating systems. The User U can establish the cloud service template 22 merely using the service builder 22.

In one embodiment, the cloud service template 22 is modularized to contain a plurality of files, featuring high readability and high reusability. In one embodiment, the cloud service template 22 has a provisioning parameter; the cloud service template parser 100 establishes a plurality of virtual environments 120 in the cloud platforms 1 and assigns a plurality of virtual resources to the virtual environments 120 according to the provisioning parameter. In one embodiment, the virtual environment may be at least one of a virtual machine or a container. Besides, the hardware source of at least one physical server may be assigned to establish a plurality of virtual resources. The persons having ordinary knowledge in the field should be able to modify or vary the embodiments of the present invention without departing from the scope of the present invention.

In one embodiment, the cloud service template 22 is realized by a markup language. The markup language may be but is not limited to be YAML (YAML Ain't a Markup Language) or JSON (JavaScript Object Notation). In the case of using YAML, the cloud service template 22 has an orchestration parameter, a monitoring management parameter, and a configuration tool management parameter:

Orchestration:
instance1:
   type: OS
   temp: mysql.yaml
   monitoring: check mysql.xml
instance2:
   type: K8S
   temp: nginx.yml
   params:
      -mysql_ip: instance1.outputs.mysql.ip
   configurable: True

The parameter “type” indicates the type of IaaS; the parameter “temp” indicates the orchestration template disposed in IaaS; the parameter “params” indicates the specified parameters needed by the orchestration template; the parameter “monitoring” indicates whether the virtual machine or container can be monitored; the parameter “configurable” indicates whether the virtual machine or container is configurable, wherein “mysql.yaml” indicates that the orchestration template is edited according to the format of “OpenStack Heat Orchestration Template”; “check mysql.xml” indicates that the template is edited according to the template format of the “Zabbix” monitoring system and used to define the health status of the cloud service and the condition for informing the user of abnormality; “nginx.yml” indicates that the orchestration template is edited according to the format of “Kubernetes”; the parameter instruction “instance1.outputs.mysql.ip” orchestrates a plurality of IP addresses. According to the abovementioned cloud service template 22, a virtual machine is established in the cloud platform 1 for providing a data storage service element; a container is established in the cloud platform 1 for providing a webpage used in the front-end service element. Next, the IP addresses of the virtual machine and the container interconnect with each other inside an identical firewall to establish a cloud service. In other words, according to the orchestration parameter of the cloud service template 22, the cloud service template parser 100 orchestrates a plurality of virtual environments 120 communicatively interconnecting inside an identical firewall, wherein the plurality of virtual environments 120 respectively have different IP addresses; the virtual machine can be monitored; the container is configurable. Next, according to the monitoring management parameter and the configuration tool management parameter, the cloud service template parser 100 installs a monitoring agent application (so-called agent) in the monitorable virtual machine and sets up the corresponding parameter group; the cloud service template parser 100 also installs configuration tool agent program in the configurable container and sets up the corresponding parameter group. The technology and embodiments thereof will be described below.

In the conventional cloud service technology, after the cloud service has been established, the user has to enter each virtual machine or each container to dispose the management tools (including the management applications and the agent applications) and set up the corresponding parameter groups, whereby the user can manage the cloud service operating in the virtual machine or container in the future. However, the disposition and setting up of the management tools is very difficult and laborious for the user. For the case where the management tool is the SaltStack configuration management tool, a configuration tool management application (such as Salt Master) must be installed in the control node; a configuration tool agent program (such as Salt Minion) must be installed in each compute node; multitudinous implementation parameters and environment parameters must be set up in all the compute nodes. In the case of Salt Master, more than 50 parameters (called the first parameter group below) are set up, which may be but are not limited to be interface, auto_accept, file_roots, pillar_roots, firewall, etc. In the case of Salt Minion, more than 60 parameters (called the second parameter group below) are set up, which may be but are not limited to be Salt Minion, hostname, firewall, etc. For the case where the management tool is the Zabbix monitoring system, a monitoring management application (such as Zabbix Server) is normally installed in each compute node; a monitoring agent application (such as Zabbix Agent) is installed in each compute node; multitudinous implementation parameters and environment parameters must be set up in all the compute nodes. In the case of Zabbix Server, more than 70 parameters (also called the first parameter group) are set up, which may be but are not limited to be MySQL, DBHost, DBName, DBUser, DBPassword, firewall, etc. In the case of Zabbix Agent, more than 40 parameters (also called the second parameter group) are set up, which may be but are not limited to be agent host information, monitored items, conditions to trigger abnormality, Server, Hostname, ListenIP, ServerActive, LogFile, Include, monitoring scenarios, firewall, etc.

Generally to speak, the abovementioned parameters include many different parameters, such as the link parameter, the firewall parameter, the setting-up parameter, the monitoring parameter, and the account parameter. While the user enters each virtual machine or each container to dispose the agent tools and set up the corresponding parameter groups, human factors, such as ocular fatigue, inexperience and wrong keying, may cause the user to incorrectly set up the parameters and result in abnormal operation of the cloud service. Contrarily, while establishing a cloud service, the method of the present invention installs an agent application in the virtual environment of each compute node and sets up the corresponding parameter groups simultaneously, exempting the user from setting up multitudinous parameters in all the compute nodes, and saving the user a lot of time.

As mentioned above, the cloud service template parser 100 establishes a plurality of virtual environments 120 in the cloud platform 1. Next, the cloud service template parser 100 parses the cloud service template 22 and installs an agent application 122 in each virtual environment 120 of each compute node 12. In one embodiment, the agent application 122 contains a configuration tool agent program or a monitoring agent program. Therefore, according to the configuration tool management parameter or the monitoring management parameter of the cloud service template 22, the cloud service template parser 100 installs the configuration tool agent program or the monitoring agent program in the virtual environments 120. In one embodiment, the configuration tool agent program is the Salt Minion application program or the Puppet Slave application program; the monitoring agent program is the Zabbix Agent application program or the Nagios Agent application program. However, the present invention is not limited by the abovementioned embodiment.

Refer to the sole FIGURE again. The cloud service template parser 100 parses the cloud service template 22, sets up a first parameter group corresponding to the management application 102 in the controller node 10 and sets up a second parameter group corresponding to the agent application 122 in each virtual environment 120. For the case of the SaltStack configuration management tool, the first parameter group is needed by SaltMaster, and the second parameter group is needed by Salt Minion. For the case of the Zabbix monitoring system, the first parameter group is needed by Zabbix Server, and the second parameter group is needed by Zabbix Agent. Thereby, the SaltStack configuration management tool and the Zabbix monitoring system can run normally in the controller node 10 and the compute node 12, and the user U can manage the cloud service through the management application 102 communicatively connected to the agent application 122.

In one embodiment, the cloud service template parser 100 automatically sets up the first parameter group and the second parameter group and installs the agent application 122 in the virtual environments 120 through an installation tool, which may be but is not limited to be a cloud initialization tool Cloud-Init. For example, while the cloud service template parser 100 parses the cloud service template 22 and learns that a container is configurable and able to function as a webpage, the cloud service template parser 100 automatically installs a configuration tool agent program (such as Salt Minion or Puppet Slave) in the container, sets up the second parameter group corresponding to the configuration tool agent program, and sets up the first parameter group corresponding to the configuration tool management program (such as Salt Master or Puppet Master) in the controller node 10 through the cloud initialization tool. While the cloud service template parser 100 parses the cloud service template 22 and learns that a virtual machine is monitorable and able to function as a data storage and that service programs and application programs should be monitored, the cloud service template parser 100 automatically installs a monitoring agent program (such as Zabbix Agent or Nagios Agent) in the virtual machine, sets up the second parameter group corresponding to the monitoring agent program, and sets up the first parameter group corresponding to the monitoring management program (such as Zabbix Server or Nagios Server) in the controller node 10 through the cloud initialization tool. It should be noted: while the cloud service is established, the abovementioned processes are also completed simultaneously.

After the cloud service is established and while the cloud service is running, the user U can anytime reconfigure, update or monitor the cloud service through a management interface, such as an application programming interface (API). In one embodiment, the user U may transmit a management requirement (reconfiguration, update or monitoring) in a format of *.sls or *.pp to the configuration tool management program or the monitoring management program. However, the present invention does not limit that the format must be*.sls or *.pp. In one embodiment, the management interface of the cloud service template parser 100 allows the user U to establish a manifest. Therefore, while the cloud service is running, the configuration tool agent program can reconfigure or update the applications in the virtual machine or container according to the management requirements of the user U. The monitoring agent program will persistently return the data that should be monitored to the monitoring management program. Through the management interface, the user U can view data or receive abnormality notification in real time. In other words, the cloud service template parser 100 manages the cloud service according to the manifest through the management application 102 communicatively connected to the agent application 120.

In conclusion, the present invention provides a cloud service management method, which automatically installs an agent program in each virtual environment while the cloud service is being established and sets up corresponding parameter groups to enable the user to manage the cloud service in real time, and which automatically acquires the information needed by the parameter groups through installing tool programs to exempt the service provider or user from installing management tools to the multitudinous virtual machines or containers one by one, whereby a lot of time is saved. In the conventional cloud service technology, the service provider or user has to spend tens of minutes to several hours in setting up management tools by themselves (the time spent is dependent on the number of the virtual machines or containers). The cloud service management method of the present invention not only exempts the service provider or user from spending any time in setting up management tools but also prevents from incorrect operations caused by human factors.

What is claimed is:

1. A cloud service management method, for managing an Internet-based cloud computing service, comprising steps:
providing a controller node having a cloud service template parser and a management application;
providing a service builder for a user to set up a cloud service template and transmitting the cloud service template to the cloud service template parser;
the cloud service template parser parsing the cloud service template, establishing a plurality of virtual environments in a cloud platform, installing an agent application in each virtual environment, setting up a first parameter group corresponding to the management application in the control node, and setting up a second parameter group corresponding to the agent application in each virtual environment, so as to provide a cloud service; and
managing the cloud service through the management application communicatively connected to the agent application.

2. The cloud service management method according to claim 1, wherein the first parameter and the second parameter group include at least one of a link parameter, a firewall parameter, a setting-up parameter, a monitoring parameter, and an account parameter.

3. The cloud service management method according to claim 1, wherein the cloud service template parser automatically sets up the first parameter group and the second parameter group and installs the agent application through an installation tool.

4. The cloud service management method according to claim 3, wherein the installation tool is a cloud initialization tool Cloud-Init.

5. The cloud service management method according to claim 1, wherein the management application includes a configuration tool management program, and the agent application includes a configuration tool agent program, and wherein the step of managing the cloud service includes reconfiguring or updating the cloud service.

6. The cloud service management method according to claim 1, wherein the cloud service template includes a configuration tool management parameter, and wherein the step of providing the cloud service includes the cloud service template parser setting up the first parameter group and the second parameter group and installing the agent application according to the configuration tool management parameter.

7. The cloud service management method according to claim 1, wherein the management application includes a monitoring management program, and the agent application includes a monitoring agent program, and wherein the step of managing the cloud service includes monitoring the cloud service.

8. The cloud service management method according to claim 1, wherein the cloud service template includes a monitoring management parameter, and wherein the step of providing the cloud service includes the cloud service template parser setting up the first parameter group and the second parameter group and installing the agent application according to the monitoring management parameter.

9. The cloud service management method according to claim 1, wherein the step of managing the cloud service includes providing a management interface in the cloud service template parser to enable a user to establish a manifest, and wherein the cloud service template parser manages the cloud service according to the manifest.

10. The cloud service management method according to claim 9, wherein the management interface includes a graphic user interface (GUI) or an application programming interface (API).

11. The cloud service management method according to claim 1, wherein the virtual environment includes at least one of a virtual machine or a container.

12. The cloud service management method according to claim 1, wherein the cloud service template includes a markup language format.

13. The cloud service management method according to claim 1, wherein the cloud service template parser is generated by a web application framework.

14. The cloud service management method according to claim 1, wherein the cloud service template includes a provisioning parameter, and wherein the cloud service management method further comprises a step of assigning a plurality of virtual resources to the plurality of virtual environments according to the provisioning parameter.

15. The cloud service management method according to claim 14, wherein the cloud service template includes an orchestration parameter, and wherein the cloud service management method further comprises a step of orchestrating the plurality of virtual environments to communicatively interconnect inside a firewall, and wherein the plurality of virtual environments have a plurality of different IP addresses.
